(19) United States
(12) Patent Application Publication
(10) Pub. No.: US 2016/0293059 A1
(43) Pub. Date: Oct. 6, 2016

(54) TRAINING TEAT UNIT

(71) Applicant: MEDELA HOLDING AG, Baar (CH)

(72) Inventors: Mario Rigert, Buchrain (CH); René Fischer, Zurich (CH); Florian Beutter, Horgen (CH)

(21) Appl. No.: 15/036,657

(22) PCT Filed: Nov. 18, 2014
(86) PCT No.: PCT/EP2014/074895

§ 371 Date: May 13, 2016

(30) Foreign Application Priority Data
Nov. 26, 2013 (CH) 1961/13

(51) Int. Cl. G09B 23/30; A61J 11/00; A61J 17/00

(52) U.S. Cl. CPC G09B 23/30; A61J 17/008; A61J 11/0035

(57) ABSTRACT

A training teat unit for premature babies has a shield, and a teat connected to the shield and having a mouthpiece. The teat has a base body, which forms a mouth support, wherein the mouthpiece adjoins the base body and narrows in relation to the base body. At least one cavity with at least one suction opening is present in the mouthpiece for the purpose of making available a food droplet or a reward droplet, wherein the cavity is closed except for the at least one suction opening. This training teat unit permits motivation-based and optimal training of the sucking action of a premature baby.

The present application is the US national phase of International Patent Application No. PCT/EP2014/074895, filed Nov. 18, 2014, which application claims priority to Switzerland Application No. CH 1961/13, filed Nov. 26, 2013, which is hereby incorporated by reference.

### TECHNICAL FIELD

The present invention relates to a training teat unit for premature babies.

### PRIOR ART

The survival chances of a premature human baby are today much higher than they were some years ago. Since the baby is usually too weak to drink from the mother's breast, it is fed artificially. However, to ensure that it does not become accustomed to this type of feeding, and so that it is able to develop the natural reflexes that a baby born at term automatically possesses, many attempts have also been made to promote the sucking action.

WO 2012/118658 relates to a pacifier or dummy for premature babies, which is designed to encourage the premature baby to suck and to promote the coordination between sucking, swallowing and breathing. This dummy has a rectangular hollow teat, which is secured on a soft shield with a soft handle. The tip of the teat can be open to allow an intubation tube to be passed through.

Teats and dummies serving different purposes are also known from the prior art. Thus, U.S. Pat. No. 8,357,117 discloses a teat for a feeding bottle, wherein the teat has a retention lip in the mouthpiece. During use, this lip holds an inserted medicine tablet, such that the tablet is dissolved by the milk flowing through the teat, and the medicine is delivered to a baby. U.S. Pat. No. 8,357,117 discloses a pacifier into which a medicine tablet can likewise be inserted, the tablet in this case being dissolved by the baby's saliva.

DE 10 2011 107 942 describes a dummy or pacifier for administering X-ray contrast media. For this purpose, a tube is secured on the rear face of the dummy, opens into a through-hole of the teat and is welded thereto.

WO 2013/074319 discloses a pacifier with a forked front part. An upper area of this forked part comes to lie over the human tongue, while a lower part comes to lie underneath the tongue. Medicine is administered through the lower part, such that the patient or the baby is forced to swallow the medicine.

EP 2 586 420 discloses a spoon-shaped pacifier intended to make it easier for a baby to change from liquid food to solid food.

U.S. Pat. No. 1 985 further discloses an artificial breast for babies who do not want to drink from bottles. This artificial breast comprises a glass body in the shape of a breast and, placed on top of this, a sponge connected to a feeding bottle.

### DISCLOSURE OF THE INVENTION

It is therefore an object of the invention to create a training teat unit which allows a premature human baby to develop an optimal sucking action and, by training, to increase the sucking force.

The training teat unit according to the invention for premature babies has a shield, and a teat connected to the shield and having a mouthpiece. The teat has a base body, which forms a mouth support. The mouthpiece adjoins the base body and narrows in relation to the base body. At least one cavity with at least one suction opening is present in the mouthpiece for the purpose of making available a food droplet or a reward droplet, wherein the cavity is closed except for the at least one suction opening. In the following, a food droplet or a reward droplet are mentioned, wherein these expressions mean a single droplet but also a few of several droplets.

By virtue of its mouth support, this training teat unit simulates a teat for fastening on a feeding bottle and/or simulates a mother's breast. The premature baby can thus become accustomed at an early stage to the shape of the teat or nipple. Later nipple confusion can be avoided in this way. This also permits a more rapid switch from feeding tube to bottle feed or the mother's breast.

The training teat unit according to the invention has the important advantage that the baby receives a reward in the form of a food droplet as soon as it shows the first signs of a sucking action and/or deforms the teat with sufficient pressure. The training teat unit thus creates an incentive to further training of the sucking action.

The baby cannot choke during training, since only a few droplets are made available, in particular just a single droplet, and no liquid follows this. The training teat unit serves only for training purposes, not for feeding. The capacity of the cavity is preferably quite small, preferably less than 5 ml.

Depending on the embodiment, several food droplets or reward droplets can also be present in the at least one cavity, these droplets being continuously released until the cavity is empty. Here too, the premature baby cannot choke or be made unwell, since the amount of liquid administered is still very small.

The food droplets or reward droplets offered are preferably breastmilk. However, it is also possible to use other types of liquids if they are appropriate for premature babies.

The at least one cavity can be filled in different ways with the food droplet or the reward droplet. For example, the teat can be dipped into a liquid, in particular into expressed breastmilk, until the at least one cavity is filled. The food droplet or the reward droplet can also be introduced into the at least one cavity using a syringe, a pipette or another suitable means.

A further advantage is that the training teat unit with the food droplet or the reward droplet has a soothing effect on the premature baby. It reduces stress, promotes digestion and eases any pain felt by the child.

In a preferred embodiment, the teat is hollow. It is thus flexible and, in the mouth of the premature baby, feels like the teat of a feeding bottle that will be later used.

Preferably, the at least one cavity is arranged in a free end area of the mouthpiece. It is preferably situated in the free tip, i.e. in the very front free end of the mouthpiece. In one embodiment, this is the only cavity. This cavity can be easily filled, both by immersion of the tip of the mouthpiece and also by means of a syringe or a pipette.

Preferably, a closed partition wall is present in the teat, extends approximately perpendicularly with respect to a longitudinal centre axis of the teat and closes the at least one cavity in a fluid-tight manner. The partition wall permits a hollow design of the rest of the teat. This partition wall is also easy to produce.

In a preferred embodiment, at least one of the suction openings in a free end of the mouthpiece is arranged centrally with respect to a longitudinal centre axis of the mouthpiece, wherein a first of the at least one cavity is open towards this free end and ends in this suction opening. Further cavities and suction openings may be present. In one embodiment, however, only this upper cavity, also called chamber, and only this one central suction opening are present. In another embodiment, there is just one cavity, but further suction openings are also present, wherein these are distributed about the circumference of the mouthpiece and connect the cavity likewise to the outside of the mouthpiece.

In one embodiment, in addition to or as an alternative to this upper cavity and this central suction opening, a plurality of suction openings and cavities are present, wherein at least some or all of these suction openings and cavities are formed by grooves, which are formed in an outer face of the mouthpiece. If only grooves are present, the overall volume of the food droplet or the reward droplet can correspond to that of the chamber, but the premature baby obtains this volume at intervals and not necessarily all at one time.

Preferably, the grooves run at least approximately parallel to a longitudinal centre axis of the mouthpiece. This encourages the premature baby to take the teat as deep as possible into the mouth.

Preferably, the grooves are distributed uniformly about a circumference of the mouthpiece. This ensures that the premature baby does not become used to an asymmetry that would not be present on the mother's breast.

In a preferred embodiment, the grooves end at a distance from the free end of the mouthpiece. This is especially advantageous if the chamber and the central suction opening are additionally present.

In a preferred embodiment, each groove has a peripheral suction opening, which leads outwards from the chamber. In this case, the grooves are thus connected to the chamber. The food droplet or the reward droplet can be made available in the chamber alone, or the grooves can likewise be filled from the start. The latter case optimizes training: the premature baby gets a reward from the grooves with relatively little effort. If the baby sucks with more force or in a more specific way, the food droplet or the reward droplet also passes from the chamber to the grooves. The baby thus learns to build up a sucking force and practices the sucking action.

In a preferred embodiment, at least some of the suction openings are distributed about the circumference of the mouthpiece and lead outwards from at least one cavity arranged in the interior of the mouthpiece.

In a preferred embodiment, precisely one suction opening is present, this preferably being the abovementioned central suction opening. However, it can also be arranged off-centre or on the circumference of the mouthpiece.

In one embodiment, the mouthpiece has a solid free end, wherein an outer face of the free end has a multiplicity of blind holes, which form the cavities and the suction openings. Here, there is preferably no inner chamber present, and therefore also no continuous suction opening. In the same way as with the grooves, the premature baby gains a reward with little effort and with minimal sucking force, since the blind holes dispense the liquid quite quickly.

In one embodiment, the mouthpiece has a free end, which is porous and thus forms the cavities and suction openings. This end can be formed by a sponge, which is formed integrally on the teat or which is inserted into the upper cavity or chamber and is held fixed in the latter.

Preferably, the shield has a through-opening surrounded by the teat. The teat is thereby hollow, and a hollow space of the teat thus formed is open with respect to this through-opening. The at least one cavity is separated from the hollow space in a fluid-tight manner, for example by the abovementioned partition wall.

Further embodiments are set forth in the dependent claims.

### BRIEF DESCRIPTION OF THE DRAWINGS

Preferred embodiments of the invention are described below with reference to the drawings, which are provided only for explanatory purposes and are not to be interpreted as limiting the invention. In the drawings:

FIG. 1 shows a perspective view of a training teat unit according to the invention in a first embodiment;

FIG. 2 shows a side view of the unit in FIG. 1;

FIG. 3 shows a perspective view of the underside of the unit in FIG. 1;

FIG. 4 shows a longitudinal section through the unit in FIG. 1;

FIG. 5 shows a perspective view of a training teat unit according to the invention in a second embodiment;

FIG. 6 shows a side view of the unit in FIG. 5;

FIG. 7 shows a longitudinal section through the unit in FIG. 5;

FIG. 8 shows a perspective view of a training teat unit according to the invention in a third embodiment;

FIG. 9 shows a longitudinal section through the unit in FIG. 8;

FIG. 10 shows a longitudinal section through a training teat unit according to the invention in a fourth embodiment;

FIG. 11 shows a longitudinal section through a training teat unit according to the invention in a fifth embodiment;

FIG. 12 shows a perspective view of a training teat unit according to the invention in a sixth embodiment;

FIG. 13 shows a longitudinal section through the unit in FIG. 12;

FIG. 14 shows a perspective view of a training teat unit according to the invention in a seventh embodiment;

FIG. 15 shows a longitudinal section through the unit in FIG. 14;

FIG. 16 shows a perspective view of a training teat unit according to the invention in an eighth embodiment;

FIG. 17 shows a longitudinal section through the unit in FIG. 16;

FIG. 18 shows a perspective view of a training teat unit according to the invention in a ninth embodiment;

FIG. 19 shows a longitudinal section through the unit in FIG. 18;

FIG. 20 shows a perspective view of a training teat unit according to the invention in a tenth embodiment, and

FIG. 21 shows a longitudinal section through the unit in FIG. 20.

### DESCRIPTION OF PREFERRED EMBODIMENTS

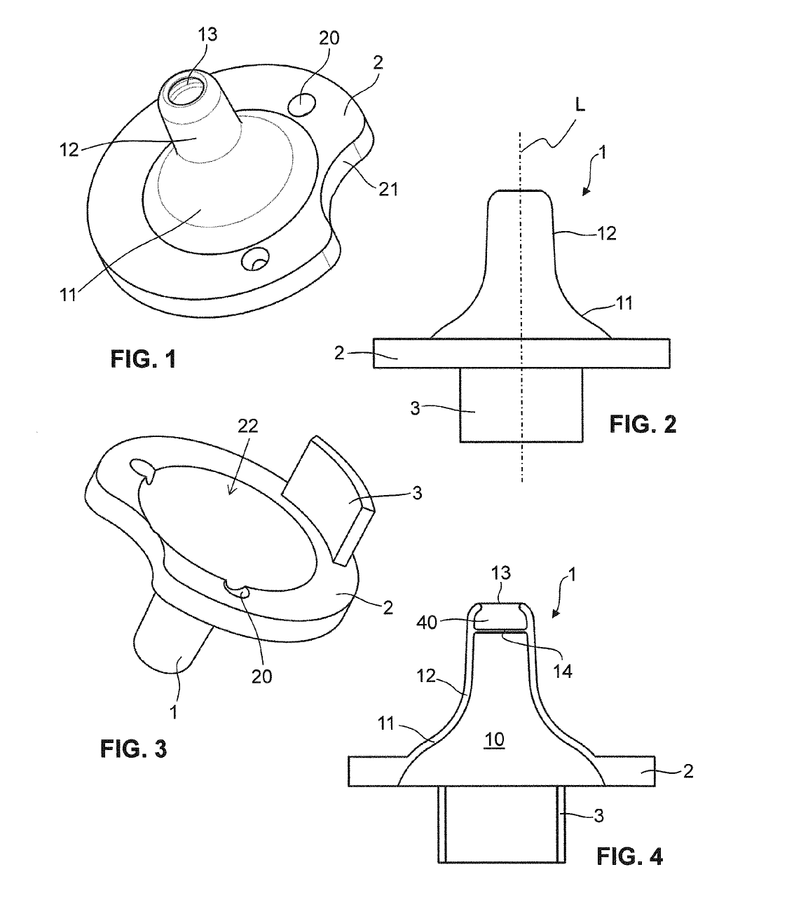

FIGS. 1 to 4 show a first illustrative embodiment of the training teat unit according to the invention. The unit comprises a teat 1 and a shield 2. The teat 1 is made from a soft flexible material, for example from silicone. The shield 2 can likewise be made from silicone. It can be hard or soft. However, it is preferably quite soft.

The teat 1 can be made in one piece with the shield 2. In particular, it can be injection-moulded onto or produced together with the shield 2 by single-component or two-component injection-moulding. However, the teat 1 can also be secured on the shield 2, for example by adhesive bonding or welding.

The shield 2 is annular and has two mutually opposite plane surfaces. The circular outer periphery is interrupted by a recess 21. This recess forms a recess for the nose of the premature baby, so that breathing through the nose is still possible. At least one continuous emergency breathing hole 20 is preferably present in the shield 2. If the premature baby takes the whole shield into its mouth, breathing through the mouth is still possible by virtue of this through-opening 20. The shield 2 thus substantially corresponds in form and shape to the known pacifiers.

A grip 3 is integrally formed on the shield 2 or is secured thereon. It preferably extends, on the side of the shield 2 facing away from the teat 1, perpendicularly with respect to the plane surfaces. It runs along only a fraction of the periphery of the shield 2.

The grip 3 allows the training teat unit to be held by hand. The grip 3 can be solid like the shield 2 and, in particular, can be made in one piece with the latter. However, it can also be soft, in particular flexible, such that the premature baby does not get any pressure sores if its head comes to lie on the grip 3.

The teat 1 has a base body 11 and, adjoining the latter, a mouthpiece 12 formed in one piece with the base body 11. The teat is hollow, and its hollow space 10 is open with respect to a through-opening in the shield 2. The hollow space 10 is therefore accessible from the outside, specifically from the side facing away from the mouthpiece 12.

The base body 11 is hemispherical or dome-shaped. It constitutes a mouth support, i.e. the lips of the premature baby enclose this base body 11 during optimal use, such that the mouthpiece 12 is received fully in the child's mouth, but not the entire base body 11. The height at which the child's lips come to lie on the curved flank of the base body 11 differs between individuals.

The mouthpiece 12 narrows in relation to the base body 11. Starting from the area of transition to the base body 11, it can have a cylindrical shape as far as a free end, or it can have the shape of a truncated cone. Other shapes are likewise possible, with preference being given to shapes that are symmetrical about a longitudinal centre axis L of the teat 1.

The teat 1 preferably has a thin wall. The base body 11 can have the same Shore A hardness as the mouthpiece 12, or the latter can be softer. In the respects hitherto mentioned with regard to its design, the teat corresponds to the known teats, in particular to the teats for premature babies.

In this embodiment according to the invention, a cavity in the form of a chamber 40 is now present which is arranged in the front end area of the mouthpiece 12, that is to say in the tip of the free end. This chamber 40 is closed in a fluid-tight manner with respect to the hollow space 10. Here, a closed partition wall 14 is present which separates the chamber 40 from the hollow space 10 and thus from the outside of the teat unit. However, on the other side, i.e. at the end of the mouthpiece 12, the chamber 40 is open. For this purpose, a central suction opening 13 is present which preferably extends centrally with respect to the longitudinal centre axis L. Instead of a single central suction opening 13, it is also possible to provide a plurality of suction openings in the tip of the mouthpiece 12, which suction openings are preferably all distributed centrally about the longitudinal centre axis L. One of the suction openings can also be arranged in the middle.

The suction opening 13 is preferably surrounded by a radially inwardly sloping wall. The suction opening 13 is preferably round but, because of the softness of the front end, it can be easily deformed by the action of an external force.

In this illustrative embodiment, the suction opening 13 is quite large. Typical diameters lie between 1 and 15 mm, preferably approximately 5 to 7 mm.

This chamber 40 can now be filled via the suction opening 13 with a reward droplet, for example with breastmilk. If the premature baby sucks gently on the mouthpiece 12 or presses it together, the droplet is drawn into the child's mouth. The child is motivated to repeat the procedure in order to gain further reward droplets.

The partition wall 14 facilitates the emergence of the droplet since, when the mouthpiece 12 is pressed together, the wall 14 can act like a membrane and pushes the droplet outwards. However, the droplet can also emerge simply on account of the deformation of the mouthpiece 12.

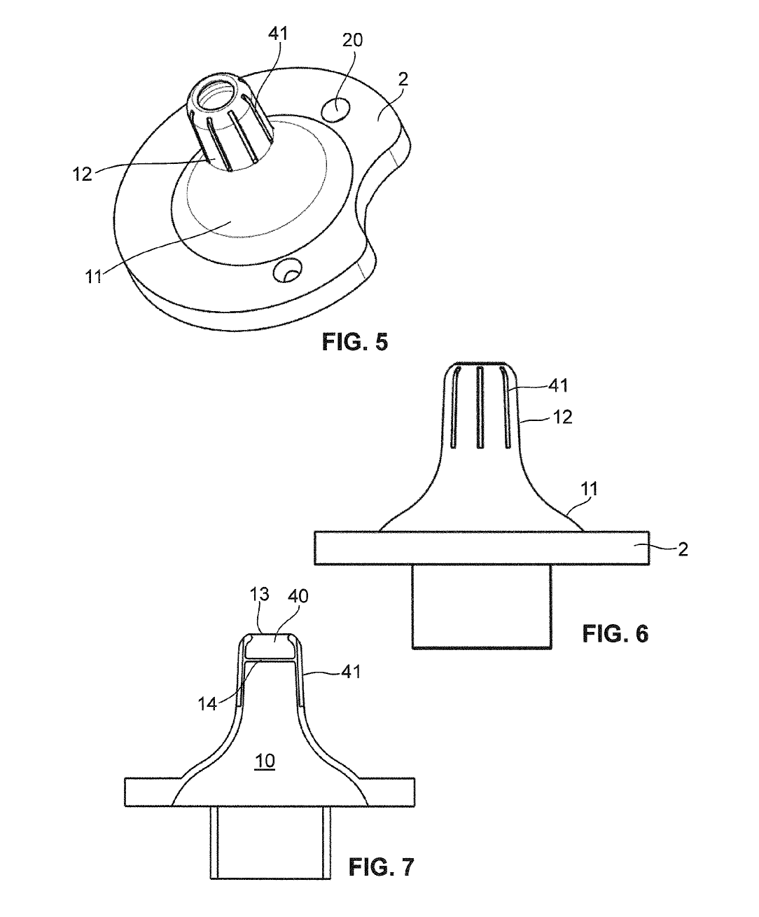

FIGS. 5 to 7 show a second embodiment of the training teat unit according to the invention. The unit is essentially designed the same as the first unit. These aspects are therefore not dealt with again. The same features are designated by the same reference signs. In addition to the chamber 40, the central suction opening 13 and the partition wall, there are now further cavities in the form of gaps or grooves 41. These run parallel to the longitudinal centre axis L, or they run along the outer face of the mouthpiece 12 towards the base body 11. They are present only in the surface and do not form through-openings into the interior of the teat 1. However, droplets of food can also be held in these grooves 41, so that the grooves 41 act simultaneously as cavity and as suction opening.

In one embodiment not shown, it is only such grooves 41 that are present, with no chamber 40 and no central suction opening 13. In this case, the partition wall 14 in the hollow teat 1 is also not needed.

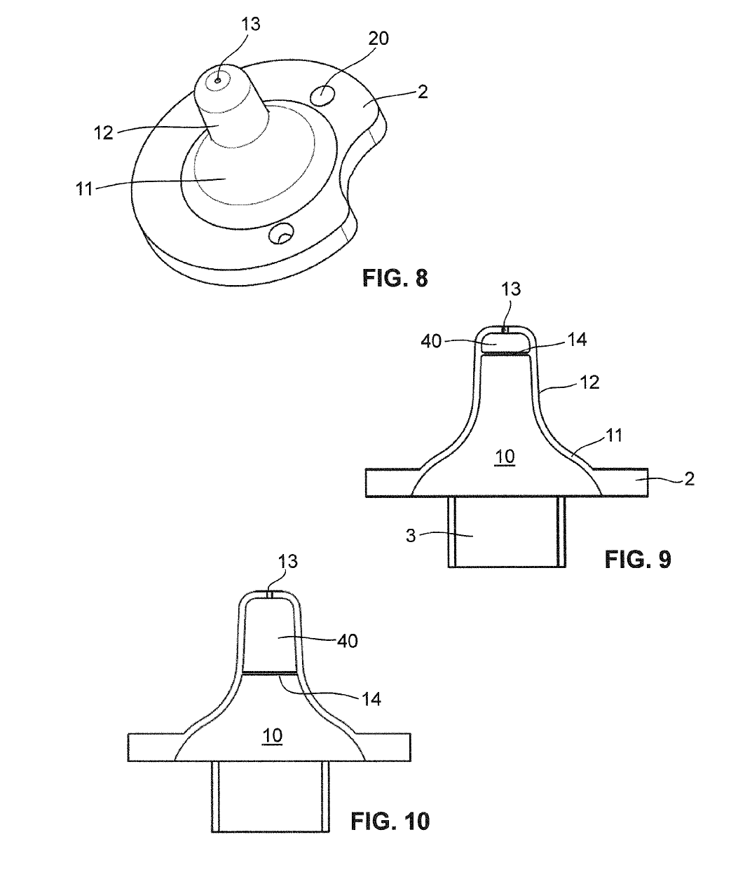

In the embodiment according to FIGS. 8 and 9, the central suction opening 13 is substantially smaller than in the first example. It is preferably likewise round. However, slits or other shapes are also possible. In the case of a round central suction opening 13, typical diameters are 0.2 to 5 mm, preferably approximately 0.5 mm.

The chamber 40 shown in FIG. 9 is about the same size as the chamber 40 of the first example. It holds less than 5 ml. Typical values are 0.01 to 2 ml, preferably 0.1 to 0.5 ml.

In the illustrative embodiment according to FIG. 10, this chamber 40 is larger. The partition wall 14 is no longer located in the upper third of the mouthpiece 12 but near the area of transition to the base body 11. The chamber 40 therefore holds typically 0.5 to 3 ml.

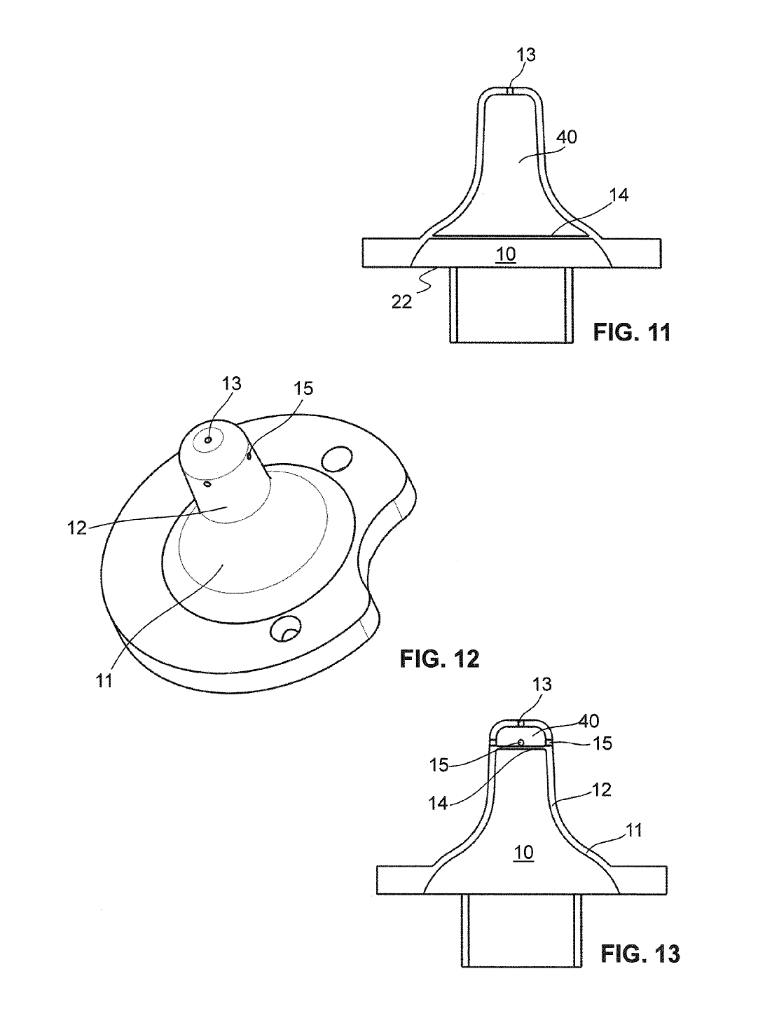

In the illustrative embodiment according to FIG. 11, the chamber 40 is even larger and extends approximately along the entire length of the teat 1. The partition wall 14 is arranged in the bottom area of the base body 11, i.e. in the area remote from the mouthpiece 12. The hollow space 10 is formed practically only by the depth of the through-opening 22 in the shield 2. The capacity of this chamber 40 is preferably 1 to 5 ml.

In the examples according to FIGS. 10 and 11, small suction openings 13 analogous to the variant in FIG. 9 are shown. However, the central suction openings 13 can also be larger, in particular as large as in the first example. Moreover, the variant according to FIGS. 5 to 7 can also be provided with a small central suction opening 13.

FIGS. 12 and 13 show a further illustrative embodiment. Here, the chamber 40 is again quite small, and the central suction opening 13 is likewise small. Further suction openings 15 are distributed about the circumference of the tip of the mouthpiece 12. These lateral suction openings 15 additionally connect the chamber 40 to the outside of the teat. These lateral suction openings 15 preferably have the same diameter as or a smaller diameter than the central suction opening. Alternatively, instead of the small central opening 13, the previously mentioned large suction opening can also be present. Moreover, it is also possible for just lateral suction openings 15 to be present, with no central suction opening 13.

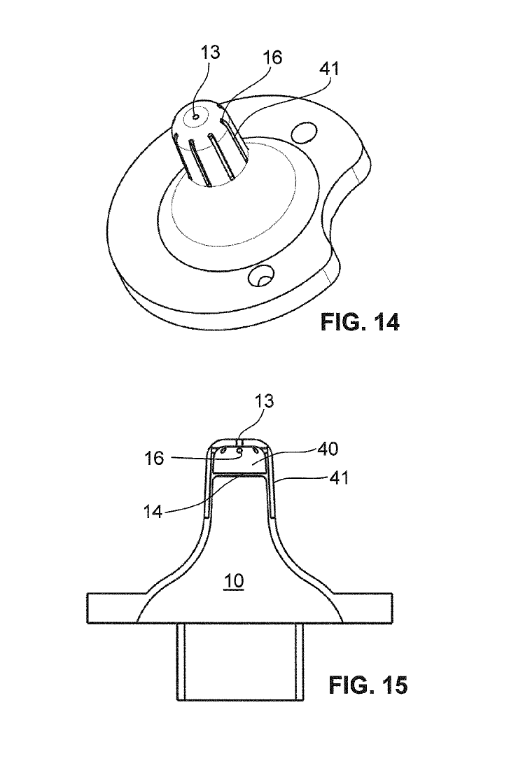

FIGS. 14 and 15 show an embodiment which combines the grooves 41 and the small central suction opening 13 with further suction openings 16, wherein these peripheral suction openings 16 form the upper ends of the grooves 41 and establish a connection between the chamber 40 and the outside of the mouthpiece. Here too, instead of the small central suction opening 13, it is possible to form a large central suction opening in a teat, or the peripheral suction openings 15 can be formed only with the grooves 41 and without a central suction opening in a teat.

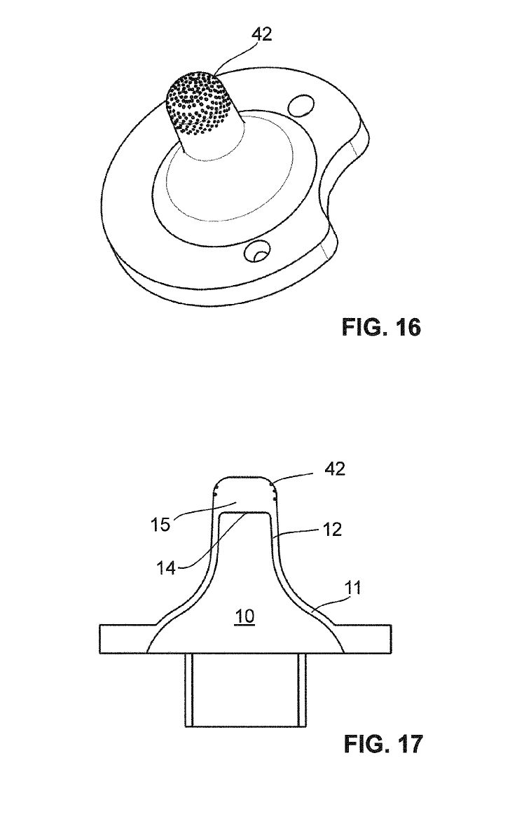

FIGS. 16 and 17 show an embodiment without chamber 40 and central suction opening 13. Here, a multiplicity of blind holes 42 are distributed across the tip or free end of the mouthpiece 12 and form the cavities and the suction openings. Similarly to the embodiments with the grooves 41, these holes 42 here form the reservoir for the liquid. They can be filled by dipping the tip into a liquid, in particular expressed breastmilk.

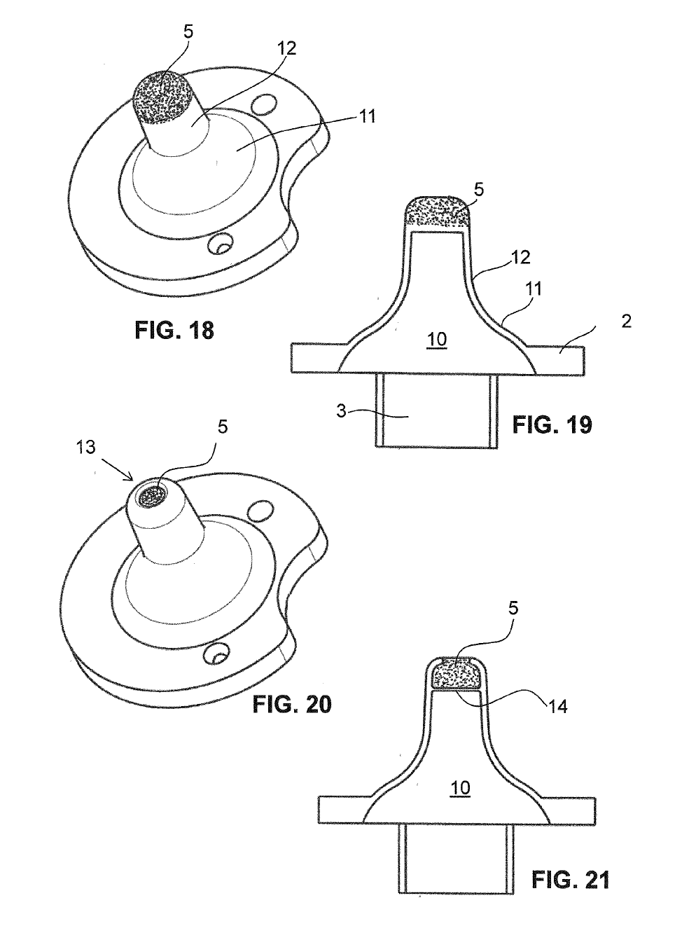

In FIGS. 18 and 19, a porous endpiece 5 or a porous tip is present instead of this multiplicity of blind holes 42. This endpiece 5 can be formed in one piece with the rest of the mouthpiece 12 or can be welded or adhesively bonded thereto. The pores form the cavities and suction openings. The porous endpiece is preferably a sponge.

In FIGS. 20 and 21, a sponge 5 or another porous element is likewise present. However, the sponge 5 or the porous material is inserted into the chamber 40. It is preferably anchored firmly in the chamber 40, e.g. adhesively bonded or welded. Moreover, it can be held in the chamber 40 by the tip of the mouthpiece 12 narrowing towards the central suction opening 13.

The training teat unit according to the invention permits motivation-based and optimal training of the sucking action of a premature baby.

What is claimed is:

1. A training teat unit for premature babies, wherein the training teat unit has a shield, and a teat connected to the shield and having a mouthpiece, wherein the teat has a base body, which forms a mouth support, wherein the mouthpiece adjoins the base body and narrows in relation to the base body, and wherein at least one cavity with at least one suction opening is present in the mouthpiece for the purpose of making available a food droplet or a reward droplet, wherein the cavity is closed except for the at least one suction opening.

2. The training teat unit according to claim 1, wherein the teat is hollow.

3. The training teat unit according to claim 1, wherein the at least one cavity is arranged in a free end area of the mouthpiece.

4. The training teat unit according to claim 1, wherein a closed partition wall is present in the teat, the closed partition wall extending approximately perpendicularly with respect to a longitudinal centre axis of the teat (1) and closing the at least one cavity in a fluid-tight manner.

5. The training teat unit according to claim 1, wherein at least one of the suction openings in a free end of the mouthpiece is arranged centrally with respect to a longitudinal center axis of the mouthpiece, and wherein a first of the at least one cavity is open towards this free end and ends in this at least one suction opening.

6. The training teat unit according to claim 1, wherein a plurality of suction openings and cavities are present, wherein at least some of these suction openings and cavities are formed by grooves, which are formed in an outer face of the mouthpiece.

7. The training teat unit according to claim 6, wherein the grooves run at least approximately parallel to a longitudinal centre axis of the mouthpiece.

8. The training teat unit according to claim 6, wherein the grooves are distributed uniformly about a circumference of the mouthpiece.

9. The training teat unit according to claim 6, wherein the grooves end at a distance from the free end of the mouthpiece.

10. The training teat unit according to claim 6, wherein at least one of the suction openings in a free end of the mouthpiece is arranged centrally with respect to a longitudinal centre axis of the mouthpiece, and wherein a first of the at least one cavity is open towards this free end and ends in this at least one suction opening and wherein each groove has a peripheral suction opening, which leads outwards from the first cavity .

11. The training teat unit according to claim 1, wherein at least some of the suction openings are distributed about the circumference of the mouthpiece and lead outwards from at least one cavity arranged in the interior of the mouthpiece.

12. The training teat unit according to claim 1, wherein precisely one suction opening is present.

13. The training teat unit according to claim 1, wherein the mouthpiece has a solid free end, and wherein an outer face of the free end has a multiplicity of blind holes, which form the cavities and the suction openings.

14. The training teat unit according to claim 1, wherein the mouthpiece has a free end, which is porous and thus forms the cavities and suction openings.

15. The training teat unit according to claim 1, wherein the shield has a through-opening surrounded by the teat, wherein the teat is hollow, and a hollow space thus formed is open with respect to this through-opening, and wherein the at least one cavity is separated from the hollow space in a fluid-tight manner.
